(19) United States
(12) Patent Application Publication
(10) Pub. No.: US 2006/0051989 A1
(43) Pub. Date: Mar. 9, 2006

(54) Multiple piece shroud

(75) Inventors: Michael J. Murphy, East Greenwich, RI (US); Glen Goodman, Cumberland, RI (US)

Correspondence Address: FISH & RICHARDSON PC, P.O. BOX 1022, MINNEAPOLIS, MN, 55440-1022, US

(73) Assignee: Advanced Interconnections Corporation, West Warwick, RI (US)

(21) Appl. No.: 10/936,008

(22) Filed: Sep. 8, 2004

(51) Int. Cl. H01R 12/00

(52) U.S. Cl. 439/80

(57) ABSTRACT

An intercoupling component includes an electrically insulated terminal base, a shroud, separate from the base, and an array of electrically conductive terminal elements. The terminal base having an array of holes configured to receive the terminal elements, each terminal element having a first end adapted for insertion into the holes of the base and a second end configured to extend outwardly from the base. The shroud includes a plurality of walls, which in aggregate define a first end and a second end. The first end of the shroud is configured to receive and be attached to the terminal base and allow the terminal elements to be positioned within the plurality of walls, and the second end is configured to allow access to the terminal elements.

### TECHNICAL FIELD

This invention relates to making electrical connections with printed circuitry.

### BACKGROUND

Management of high density interconnect is becoming increasingly important in the field of electronic assemblies. The electronics industry features a wide range of interconnection products, i.e., electrical and electronic connectors, which are employed in a countless number of applications including military and commercial products. Connectors of these types are relied on to provide mechanical and electrical interconnection between hard wire and fiber optic cable, integrated circuit (IC) packages, and printed circuitry.

In order to meet industry demands, connector manufacturers must be able to provide solutions to the problems associated with traditional connector design and manufacture. Problems associated with traditional connector designs include limited choice of materials, and, therefore, limited application. The limited choice of material is attributed, at least in part, to the fact that connector housings have been manufactured as a single piece, with the electrical contact elements subsequently inserted. Because the individual contact elements are generally employed for the purpose of carrying discrete electrical signals, the materials selected for the housings have typically been limited by the need to keep the contact elements electrically isolated. Additionally, certain mechanical problems are attributable to single piece constructions. Particularly in high density connections where the physical dimensions of the connectors are increased to accommodate an increasing number of contact elements, thin wall features of the connector housings begin to bow, which results in problems when making connections with mating connectors. Such bowing may also cause undesirable wide dimensional tolerances.

### SUMMARY

In general, the invention relates to an intercoupling component of the type for providing interconnections to printed circuitry.

In one aspect of the invention, the intercoupling component includes an electrically insulated terminal base having an array of holes configured to receive electrically conductive terminal elements, the elements having a first end adapted for insertion into the holes of the base and a second end configured to extend outwardly from the base. A shroud, separate from the base, includes a plurality of walls, which, in aggregate, define a first end. The first end of the shroud is configured to receive and be attached to the terminal base and allows the terminal elements to be positioned within the plurality of walls. The shroud also has a second end, which is configured to allow access to the terminal elements.

Embodiments of this aspect of the invention may include one or more of the following features. For example, the walls of the shroud can extend above the height of the pins. The second end of the shroud can be configured to interface with a mating component having an array of contact elements which correspond to the terminal elements of the intercoupling component. The second end of the terminal elements, extending outwardly from the base, are adapted for interconnect with corresponding contact elements of the mating intercoupling component. The first end of the terminal elements, inserted into the base, can be configured for various types of interconnect including, for example, ball grid array (BGA), pin grid array (PGA) and land grid array (LGA) interconnect. The second end of the shroud can include a key that corresponds to a key pattern on the terminal base, thereby controlling orientation of the shroud and the terminal base during assembly. The structural integrity of the shroud is improved by including structural ribs. The structural ribs are configured to fit between the terminal elements and connect opposing walls of the shroud.

Because the shroud is separate from the terminal base, the shroud and the base can comprise different materials. The shroud can comprise a material, e.g, copper, aluminum, galvanized steel, and conductive rubber, which provides shielding from radio frequency or electromagnetic interference. Additionally, the terminal base can comprise an electrically insulating material, such as glass epoxy (e.g., FR-4 glass epoxy).

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is an exploded perspective view of an intercoupling component assembly.

FIG. 1a is a perspective view of the shroud.

FIG. 2 is a cross-sectional view of the intercoupling component assembly.

FIG. 3 is a cross-sectional view of the intercoupling component assembly in connection with a mating component assembly.

FIGS. 4a-c are perspective views of the intercoupling component assembly, illustrating alternative interconnection configurations.

Like reference symbols in the various drawings indicate like elements.

### DETAILED DESCRIPTION

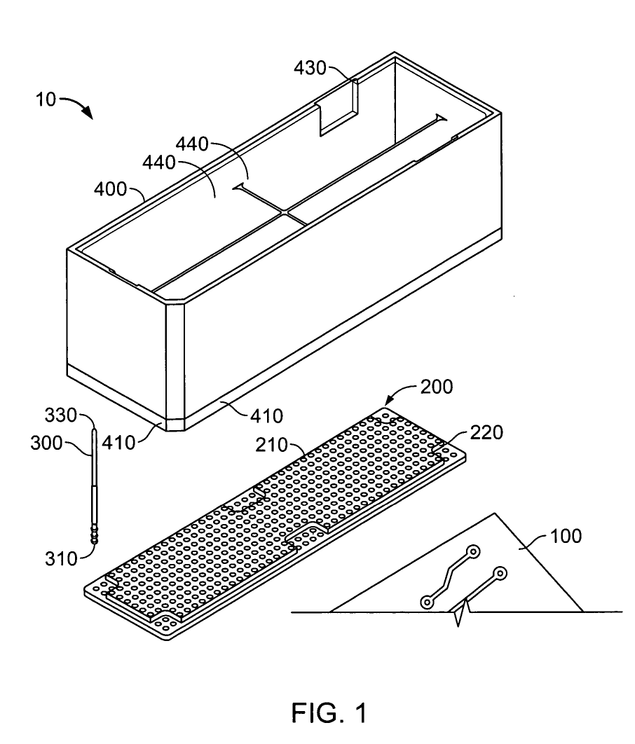

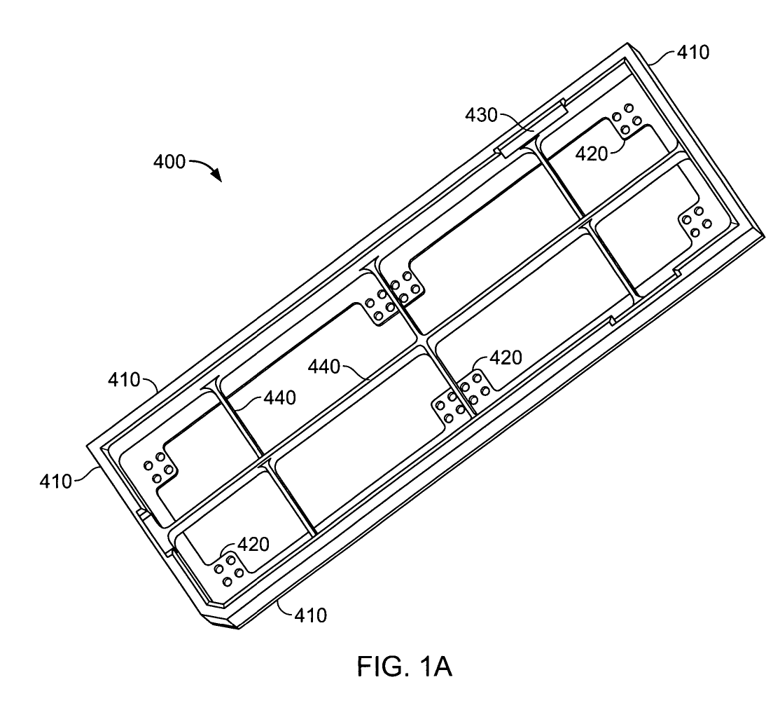

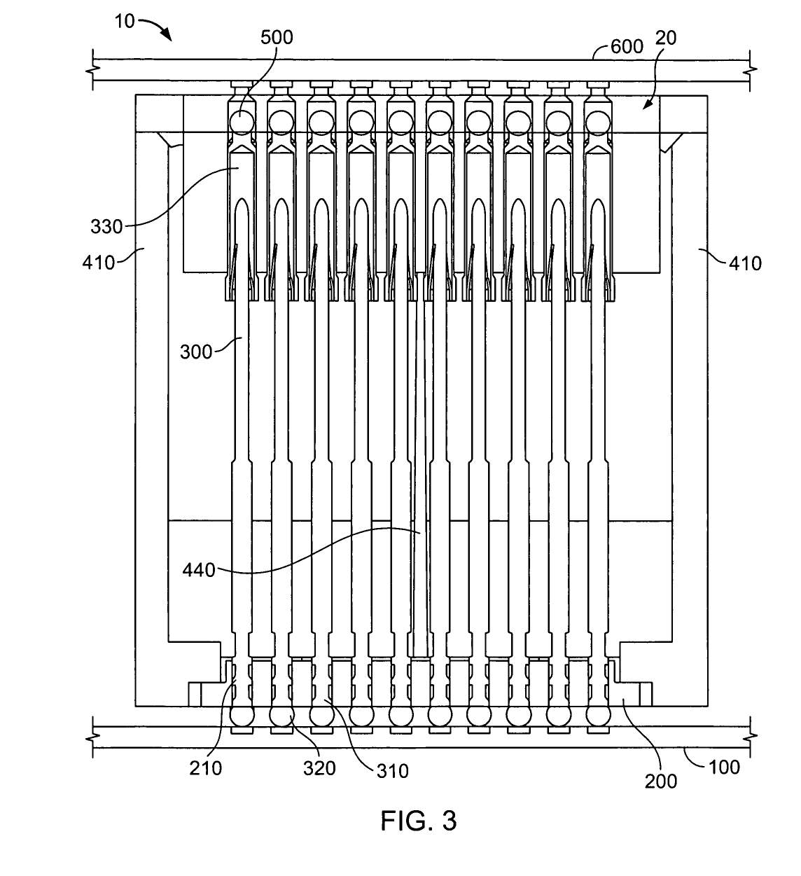

Referring to FIG. 1, a multiple-piece intercoupling component assembly 10 for electrical interconnect to a printed circuit board (PCB) 100 is shown. The intercoupling component 10 includes a base member 200 for supporting electrically-conductive terminal elements 300. Base member 200 is formed from an electrically non-conductive material, such as FR-4 glass epoxy. As shown in FIG. 1, the base member 200 includes an array of holes 210, which support the terminal elements 300. The array of holes 210 are in a pattern corresponding to an arrangement of mating terminal elements (see FIG. 3, element 500) of a mating intercoupling component (see FIG. 3, element 20) as well as a grid array footprint of PCB 100.

The base member 200 with electrically conductive terminal elements 300 are received within a shroud 400 having sidewalls 410, which, when assembled with the base member 200, sit about the periphery of the base member 200 and extend above the height of the terminal elements 300. The sidewalls 410 of the shroud 400 include a key pattern 420 (see FIG. 1a) corresponding to a mating key pattern 220 defined by the base member 200 so that the base member 200 and the sidewalls 410 are properly oriented during assembly. The key pattern 220 of the base member 200 is shown as a recessed step that follows the periphery of the base and defines a series of key features 220. The shroud 400 can also include a key pattern 430 for controlling orientation of the intercoupling component 10 with the mating intercoupling component (see FIG. 3, element 20). As illustrated in FIG. 1, the shroud includes structural ribs 440 that connect opposite walls 410 of the shroud 400 and minimize bowing of the walls.

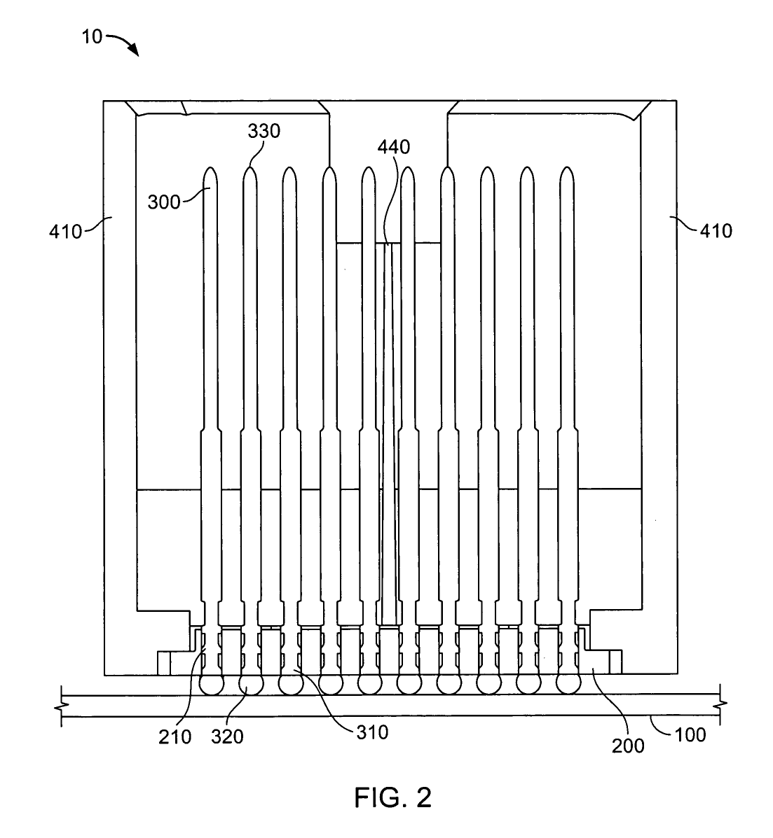

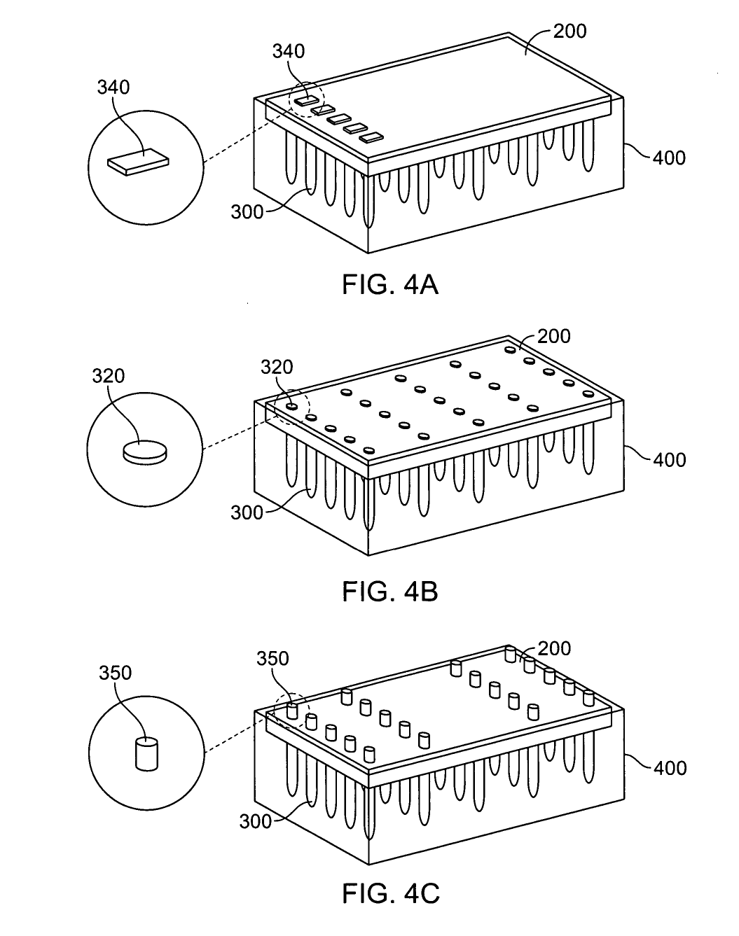

Referring to FIGS. 2 and 3, each intercoupling component assembly 10 includes a terminal element 300 positioned within one of the array of holes 210 of the base member 200. Each terminal element 300 has one end 310 that protrudes through a corresponding one of the array of holes 210 at the lower end of the base member 200. The protruding ends 310 of the terminal elements 300 are configured to contact a corresponding connection region of a PCB 100 or other substrate. As shown, the protruding ends 310 of the terminal elements 300 are configured with rounded solder balls 320 forming a BGA; however, as discussed below with respect to FIG. 4, alternative embodiments include LGA and PGA configurations. The array of rounded solder balls 320 of the BGA are generally soldered directly to a corresponding array of surface mount pads of a printed circuit board, PCB 100. Opposite ends of the terminal elements 330 extend outwardly from an upper end of the base member 200 and sit within, and are protected by, the walls 410 of the shroud 400. The terminal elements 300 are spaced so as to allow the structural ribs 440 of the shroud 400 to pass between adjacent terminal elements 300 and connect opposite walls 410 of the shroud 400.

Referring to FIG. 3, the intercoupling component assembly 10 is shown connected to a mating intercoupling component 20. The terminal elements 300 of the intercoupling component assembly 10 are configured for frictional engagement with corresponding contact elements 500 of the mating intercoupling component 20. As illustrated by FIG. 3, engagement of the intercoupling component assembly 10 with the mating intercoupling component 20 provides for the electrical interconnection of the first 10 and second 600 PCBs.

As mentioned above with respect to FIGS. 2 and 3, each terminal element 300 of the intercoupling component assembly 10 has one end 310 that protrudes through the lower end of the base member 200, which is configured for contact with a corresponding region on PCB 100. FIGS. 4a-c illustrate alternative interconnect configurations. Referring to FIG. 4a, the protruding ends 310 of the terminal elements 300 are shown in an LGA 340 configuration. FIG. 4b shows the intercoupling assembly with a BGA 320 terminal element configuration. Terminal element configurations of the BGA 320 and LGA 340 type are generally soldered directly to surface mount pads of a PCB, whereas terminal elements 300 of a PGA 350 configuration, as shown in FIG. 4c, are generally soldered into corresponding plated thru-holes of a PCB.

Referring again to the embodiment shown in FIG. 1, the terminal elements are press-fit within a corresponding one of the array of holes 210 in the base member 200. In other embodiments, the terminal elements 300 may be secured within a corresponding one of the array of holes with a conductive or non-conductive epoxy. The terminal elements 300 can be female, i.e., socket, elements or male, i.e., pin, elements as shown in FIG. 1. In some applications, it may be desirable for at least one male pin to be of a different height than every other male pin, where the height of a pin is defined as the length from the first end of the pin to the second end of the pin. Referring again to FIG. 3, varying the height of the pins serves to decrease the force required when engaging the terminal elements 300 of the intercoupling component 10 with the corresponding contact elements 500 of the mating intercoupling component 20. Varying the height of the pins also serves to decrease the force required to extract the terminal elements 300 of the intercoupling component 10 from the corresponding contact elements 500 of the mating intercoupling component 20 to which they have been engaged. The terminal elements 300 can be formed from electrically conductive materials, such as brass or copper alloy. Plating the terminal elements 300 with, for example, gold over nickel plating can mprove electrical performance.

A number of embodiments of the invention have been described. Nevertheless, it will be understood that various modifications may be made without departing from the spirit and scope of the invention. For example, the shroud 400 and the base 200 can be formed from different materials. The shroud 400, for example, can be formed from a material that offers protection from electromagnetic and/or radio frequency interference, such as copper, copper alloys, aluminum, galvanized steel, and conductive rubber. Accordingly, other embodiments are within the scope of the following claims.

What is claimed is:

1. An intercoupling component of the type for providing interconnections to printed circuitry comprising:
an electrically insulated terminal base having an array of holes configured to receive electrically conductive terminal elements, the elements having a first end adapted for insertion into the holes of the base, and a second end configured to extend outwardly from the base; and
a shroud, separate from the base, including a plurality of walls, which in aggregate define a first end, the first end of the shroud configured to receive and be attached to the terminal base and allow the terminal elements to be positioned within the plurality of walls; and a second end configured to allow access to the terminal elements.

2. The intercoupling component according to claim 1 wherein the plurality of walls extend above the height of the elements.

3. The intercoupling component according to claim 1, wherein the second end of the shroud is configured to interface with a mating component, the mating component having an array of contact elements corresponding to the elements of the intercoupling component.

4. The intercoupling component according to claim 3, wherein the second end of the elements are adapted for interconnect with corresponding contact elements of the mating intercoupling component.

5. The intercoupling component according to claim 3, wherein the second end of the shroud includes a key.

6. The intercoupling component according to claim 1, wherein the shroud further comprises structural ribs configured to connect between opposing walls of the shroud and between the terminal elements.

7. The intercoupling component according to claim 1, wherein the shroud and the base comprise different materials.

8. The intercoupling component according to claim 1, wherein the shroud comprises a material that provides shielding from electro magnetic interference.

9. The intercoupling component according to claim 1, wherein the shroud comprises a material that provides shielding from radio frequency interference.

10. The intercoupling component according to claim 1, wherein the shroud comprises a material selected from the group consisting of copper, aluminum, galvanized steel, and conductive rubber.

11. The intercoupling component according to claim 1, wherein the base comprises an electrically insulating material.

12. The intercoupling component according to claim 11, wherein the electrically insulating material comprises glass epoxy.

13. The intercoupling component according to claim 1, wherein the base includes a key.

14. The intercoupling component according to claim 1, wherein the first end of the elements are configured for pin grid array (PGA) interconnect.

15. The intercoupling component according to claim 1, wherein the first end of the elements are configured for ball grid array (BGA) interconnect.

16. The intercoupling component according to claim 1, wherein the first end of the elements are configured for land grid array (LGA) interconnect.
